(19) United States
(12) Patent Application Publication
(10) Pub. No.: US 2003/0203070 A1
(43) Pub. Date: Oct. 30, 2003

(54) Compositions containing sorbitan monoesters

(75) Inventors: Peter Yau Tak Lin, Liberty, OH (US); Paul Seiden, Cincinnati, OH (US); David Cammiade Gruber, Cincinnati, OH (US); Robert Alan Sanders, Fairfield, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/396,916

(22) Filed: Mar. 25, 2003

Related U.S. Application Data
(63) Continuation-in-part of application No. 09/965,113, filed on Sep. 26, 2001.
(60) Provisional application No. 60/367,622, filed on Mar. 26, 2002.
(60) Provisional application No. 60/235,291, filed on Sep. 26, 2000.
(60) Provisional application No. 60/235,290, filed on Sep. 26, 2000.
(60) Provisional application No. 60/235,449, filed on Sep. 26, 2000.
(60) Provisional application No. 60/235,298, filed on Sep. 26, 2000.
(60) Provisional application No. 60/235,289, filed on Sep. 26, 2000.

(51) Int. Cl. A21D 2/14

(52) U.S. Cl. 426/25

(57) ABSTRACT

Described are sorbitan-containing compositions comprising relatively high levels of sorbitan monoesters. Such compositions have numerous applications, including uses in cosmetics, hard surface cleaners, shampoos, hair conditioners, personal cleaning products, lotions, fabric softeners, pharmaceutical compositions, ice creams, whip creams, other whipped topping, confectioneries, frostings, breads, baked goods, sauces, salad dressings, snacks, and dehydrated starch ingredients.

### CROSS REFERENCE TO RELATED APPLICATIONS

This application claims the benefit of U.S. Provisional Application Serial No. 60/367,622, filed Mar. 26, 2002; and is a continuation-in-part application of co-pending U.S. application Ser. No. 09/965,113, filed Sep. 26, 2001, which claimed the benefit of U.S. Provisional Application Nos. 60/235,291, 60/235,290, 60/235,449, 60/235,298 and 60/235,289, all filed Sep. 26, 2000.

### FIELD OF THE INVENTION

The present invention relates to emulsifier compositions containing relatively high levels of sorbitan monoesters. These sorbitan monoester-containing compositions are useful for a variety of applications.

### BACKGROUND OF THE INVENTION

Current sorbitan esters are used as emulsifiers in a wide range of applications including but not limited to cosmetics, hard surface cleaners, shampoos and other personal cleaning products, industrial manufacturing, and the like. Sorbitan esters also have a variety of food and beverage applications including ice cream, whip cream, whipped toppings, confectionaries, frostings, breads, baked goods, sauces, salad dressings, and the like.

The preparation of sorbitan esters results in a number of materials, including sorbitan mono-, di- tri-, and tetraesters, isosorbide mono- and diesters, unesterified sorbitan and isosorbide, and sorbitol and esters thereof. While such combinations have utility in the aforementioned applications, Applicants have now discovered that sorbitan-containing compositions comprising relatively high levels of sorbitan monoesters are particularly useful emulsifier systems having numerous applications. Commercially available sorbitan ester compositions are commonly referred to by the industry as “sorbitan monoesters.” However, these compositions typically contain only from 25 to 35% sorbitan monoester. As discussed below, Applicants' use of the term “sorbitan monoester” refers to compositions containing sorbitan monoesters at levels greater than those described in the prior art.

The sorbitan monoesters that constitute a significant portion of the compositions described herein remain highly functional at temperatures above about 70° C., whereas the prevalent current emulsifiers, such as monoglyceride, typically lose their functionality. Applications where these properties are particularly important include baking of cakes, cookies, breads and other sweet goods; high temperature emulsion stability such as sauces and confectionaries; and highly expanded or extruded products such as cereals, rice cakes, etc. In addition to having relatively high levels of the highly functional sorbitan monoesters, the compositions of the present invention also preferably contain relatively low levels of the deleterious isosorbide esters (which are β-tending).

Another application where the properties of the compositions described herein are particularly beneficial relate to the preparation of dehydrated starch ingredients. The improved emulsifier system of the present invention can be used to reduce the level of emulsifier needed in the dehydration process, in particular, the amount of emulsifier needed as a processing aid in the drum drying operation. This reduces the cost of raw materials, as well as the potential for formation of off-flavors due to oxidation. For fat-free snacks such as those fried in olestra, the level of emulsifier in the dehydrated starch ingredients may be decreased. This allows the formulator to increase the level of other sources of triglycerides and still provide the reduced level of fat in the finished product necessary in most territories to make the fat-free claim.

Of course, the compositions of the present invention are useful in any application where an emulsifier is employed. These include, by way of example only, cosmetics, hard surface cleaners, shampoos and other personal cleaning products, lotions, fabric softeners, and pharmaceuticals.

### SUMMARY OF THE INVENTION

In one aspect, the present invention is directed to emulsifier compositions comprising a sorbitan component containing relatively high levels of sorbitan monoesters and relatively low levels of isosorbide esters. In particular, the compositions comprise a sorbitan component, wherein the sorbitan component comprises at least about 50%, by weight, sorbitan monoesters and no more than about 10%, by weight, isosorbide esters. As used herein, unless otherwise indicated, reference to the weight percent of a given sorbitan entity (e.g., sorbitan monoester, sorbitan diester, isosorbide) is with respect to the total weight of the sorbitan component (which is defined below) of the composition, not the total weight of the composition itself.

In another aspect, the present invention is directed to compositions comprising a sorbitan component, wherein the sorbitan component comprises at least about 50%, by weight, of sorbitan monoesters and wherein not more than about 50% of the sorbitan positional isomers is the 1,4 positional isomer.

In another aspect, the present invention is directed to an improved emulsifier system for making various food products including, but not limited to, dehydrated starch ingredients, wherein the emulsifier system comprises a sorbitan component, wherein the sorbitan component comprises at least about 50%, by weight, of sorbitan monoesters. Other applications include baked goods, confectionaries, sauces, cereals, etc.

In another aspect, the present invention is directed to a process for making dehydrated starch ingredients. In one particular embodiment, the process is directed to the production of dehydrated potato ingredients. The process comprises the steps of:

(a) cooking potato pieces;

(b) forming the cooked potato pieces into a potato mash;

(c) drying the potato mash to provide dehydrated potato ingredients;

(d) optionally comminuting the dehydrated mash; and

(e) adding an emulsifier system anytime prior to formation of the dehydrated potato ingredients in step (c); wherein the emulsifier system comprises a sorbitan monoester or a mixture of sorbitan monoesters.

In yet another aspect, the invention relates to dehydrated potato ingredients comprising a sorbitan monoester or a mixture of sorbitan monoesters.

In still another aspect, the invention relates to a dough composition comprising:

(a) from about 35% to about 85% of a starch-based flour comprising a dehydrated starch ingredient comprising a sorbitan monoester or a mixture of sorbitan monoesters;

(b) from about 15% to about 50% added water; and

(c) optionally a dough emulsifier.

In still another aspect, the invention relates to a food product comprising these dehydrated starch ingredients.

In still another aspect, the invention relates to a composition comprising an emulsifier system comprising a sorbitan component, wherein the sorbitan component comprises at least about 50%, by weight, sorbitan monoesters and no more than about 10%, by weight, isosorbide esters.

### DETAILED DESCRIPTION OF THE INVENTION

1. Definitions

As used herein, the term “added water” refers to water that has been added to the composition being discussed. Thus, for example, water that is inherently present in the dry dough ingredients, such as in the case of the sources of flour and starches, is not included in the term added water.

The term “alpha-stable” or “a-stable” means a material such as an emulsifier having the ability to remain in the a crystalline polymorph. It is common for emulsifiers to transition from α to β′ and subsequently to the β crystalline polymorph. Alpha-stable emulsifiers are desirable herein because of their higher emulsification functionality.

The term “comprising” means various components and processing steps can be conjointly employed in practicing the present invention. Accordingly, the term “comprising” encompasses the more restrictive terms “consisting essentially of” and “consisting of.”

The abbreviation “cp” means centipoise.

The term “dehydrated starch ingredient” refers to dehydrated potato products, dehydrated wheat product, dehydrated rice products, dehydrated corn products, and dehydrated tapioca products. These ingredients may be in the form of flakes, flanules, granules, slivers, nubbins, powder, flour, particles, or other pieces.

The terms “diacetylated tartaric acid esters of monoglycerides” and “DATEM” each refer to the mixture of products resulting from the reaction of diacetylated tartaric acid anhydride with monoglycerides. This reaction forms a complex mixture of various components, the most prevalent being diacetyl tartaric acid esters of monoglycerides (DATEM I), di-(diacetyl tartaric acid) esters of monoglycerides (DATEM II), diacetyl tartaric acid esters of diglycerides (DATEM III) and monoacetyl mono (diacetyl tartaric acid) esters of monoglycerides (DATEM IV). See Danisco Ingredients Technical Paper TP2-1e, available from Danisco Cultor (New Century, Kans.).

The term “diglycerol monoesters” and “DGME” each refers to a preferred type of polyglycerol monoester that may be used in the present invention. DGMEs are polymers of two glycerol units having one fatty acid esterified on the diglycerol backbone. Particularly preferred diglycerols are those esterified with palmitic, oleic, or stearic fatty acids, or a mixture of intermediate melting fatty acids.

The term “dispersion” refers to an emulsifier system that exists as a colloidal system in water. These systems include dilute lamellar liquid crystal, hexagonal, crystalline and mixed crystalline phases. The term “stable dispersion” refers to a dispersion that exists for at least 5 minutes at the temperature in question. The method for determining whether an emulsifier system exists as a stable dispersion is described in the Analytical Methods section of co-pending U.S. application Ser. No. 09/965,113, filed Sep. 26, 2001 by P. Lin et al.

The term “dough emulsifier” means an emulsifier or emulsifiers that are added during the dough making process in addition to the emulsifier(s) present in the dehydrated starch ingredients utilized.

The term “flour blend” refers to a mixture of all dough ingredients, excluding the water. The “flour blend” includes all dry ingredients, as well as any other ingredients such as liquid emulsifier.

The term “free polyol” refers to the portion of unesterified sorbitol, sorbitan and isosorbide in a given composition.

The terms “intermediate melting” and “IM” each mean esters formed from a mixture of fatty acids that are liquid and fatty acids that are solid at room temperature. Examples of fatty acid mixtures include, for example, mixtures of palmitic, oleic, linoleic, linolenic, stearic and other C₁₈ trans fatty acids. Partial hydrogenation is one way to produce IM fatty acid esters.

The term “lecithin” includes conventional acetylated lecithins, hydroxylated lecithins, hydrogenated and partially hydrogenated lecithins and other suitable lecithin or lecithin-like compounds such as de-oiled lecithin, lysolecithins, egg lecithins, egg yolk powder, phosphotidyl choline enriched lecithin, phosphatidic acid and its salts, lysophosphatidic acid and its salts, and phospholated monoglycerides and any mixture thereof. Also suitable are lecithins blended with other emulsifiers, e.g., CentroMix®E from Central Soya, Ft. Wayne, Ind., which is a blend of lecithin and Tween.

The term “moisture” means the total amount of water present in the material being discussed. With respect to doughs, “moisture” includes the water inherently present as well as any water that is added to the dough ingredients.

The term “monoglyceride” refers to a mixture of glycerides (mono-, di-, and triglycerides) where at least 80% of the glycerol backbones are esterified with one fatty acid. Monoglyceride can be made by the reaction of glycerin with triglyceride (i.e., glycerolysis) to produce mono-, di- and triglycerides. The desired monoglyceride content is typically achieved by molecular distillation of the above described reaction mixture. Alternatively, monoglyceride can be made by an enzymatic process.

The term “mono-diglyceride” refers to a mixture of glycerides where from about 30% to about 60% of the glycerol backbones are esterified with one fatty acid. Mono-diglyceride can be made by the reaction of glycerine with triglyceride (i.e., glycerolysis) to produce mono-, di- and triglycerides.

The terms “polyglycerol ester” and “PGE” are used interchangeably and each mean a polyglycerol ester having a polyglycerol backbone comprising from 2 to about 10 glycerol units, wherein not more than about 40% of the hydroxyl groups of the polyglycerol ester are esterified with fatty acids. For the sake of brevity, Applicants will use the following shorthand nomenclature to refer to PGEs:

No. of glycerol units- No. of esterified groups-Abbr. of the fatty acid ester group

For example, use of the shorthand “2-1-P” refers to diglycerol monopalmitate; use of the short hand “6-2-0” refers to hexaglycerol dioleate; use of “2,3-1-S” refers to di-triglycerol monostearate. With respect to this nomenclature, the following definitions apply to the fatty acid aspect of the polyglycerol ester: O=oleic acid; P=palmitic acid; S=stearic acid; and IM-intermediate melting fatty acids.

The term “psig” means pounds per square inch gauge.

The term “sheetable dough” means a dough capable of being placed on a smooth surface and rolled to the desired final thickness without tearing or forming holes.

The term “sorbitan” refers to the various positional isomers of etherified sorbitol having one ring. There are several sorbitan positional isomers, including the most commonly occurring isomers 1,4-anhydro-D-glucitol, 1,5-anhydro-D-glucitol, 2,5-anhydro-D-mannitol, 2,5-anhydro-D-iditol, and 3,6-anhydro-D-glucitol.

The term “sorbitan component,” for purposes of the present disclosure, refers collectively to sorbitol and esters thereof (mono-, di-, tri-, tetra-, penta- and hexaesters), sorbitan and esters thereof (mono-, di-, tri-, and tetraesters) and isosorbide and esters thereof (mono- and diesters). A method for determining the sorbitan component of a sample is described in the Analytical Methods section below.

The term “sorbitan monoester” refers collectively to any sorbitan positional isomer with one fatty acid esterified to one free hydroxyl group. It is understood that there are numerous ester isomers for a given sorbitan positional isomer (dictated by which free hydroxyl group is esterified). A method for determining the sorbitan monoester content of a sorbitan component is described in the Analytical Methods section below.

The terms “starch” and “modified starch” have the meanings set forth in co-pending U.S. application Ser. No. 09/965,113, filed Sep. 26, 2001 by P. Lin et al.

All amounts, parts, ratios and percentages used herein are by weight unless otherwise specified.

II Compositions Containing Sorbitan Monoesters

It is readily understood by those of skill in the art that sorbitan monoesters are typically not obtainable in pure form (i.e., are not a single sorbitan ester), and are usually mixtures of different esters. This results from the manner in which the sorbitan monoesters are prepared. For that reason, when types of molecules are mentioned herein, it is meant that the material referred to is “predominantly” that material. For instance, an emulsifier referred to as sorbitan monooleate will include that material as a significant component, but will often also include other sorbitan esters with higher degrees of esterification (e.g., di- to tetra esters), esters with other fatty acid residues (e.g., stearate), as well as unesterified sorbitan. Further, there will be unreacted sorbitol (CH₂OH)—(CHOH)₄CH₂OH, the linear precursor to sorbitan), isosorbide (bicyclic side product) and esters thereof, and other “impurities” as well, as will be understood and appreciated by one of skill in the art.

The compositions of the present invention will comprise a sorbitan component wherein at least about 50%, by total weight of the sorbitan component, is sorbitan monoester(s). As indicated above, this level of sorbitan monoester is greater than the levels in current sorbitan compositions. The compositions of the present invention can be made by either further purifying commercial sorbitan compositions, or by controlling the synthesis of the sorbitan starting with sorbitol. In another aspect, the composition will comprise a sorbitan component wherein at least about 60%, by total weight, of the component is sorbitan monoester(s). In another aspect, the composition will comprise a sorbitan component wherein at least about 70%, by weight, of the component is sorbitan monoester(s). Typically, the composition will comprise a sorbitan component comprising from about 50% to about 98%, by total weight, sorbitan monoester(s). In this aspect, the composition's sorbitan component will comprise not more than about 10%, by weight, isosorbide esters. Typically, the sorbitan component will comprise not more than about 7%, still more typically not more than about 4%, isosorbide esters.

For purposes of the present invention, to achieve the greatest functionality, it is preferred that the sorbitan component contains a mixture of the monoesters of the various sorbitan positional isomers. Without wishing to be bound by any particular theory, it is believed that monoesters of a mixture of sorbitan positional isomers leads to polymorphic behavior that is alpha-tending and perhaps alpha-stable. Alpha-tendency and alpha-stability result in more highly functional emulsifiers, particularly at relatively high temperatures. Accordingly, it is preferred in one aspect that the sorbitan component will comprise not more than about 50%, by total weight, of a particular sorbitan positional isomer (e.g., the 1,4 positional isomer). In another aspect, the sorbitan component will comprise not more than about 40%, by total weight, of a particular sorbitan positional isomer.

The compositions useful herein will typically comprise relatively low levels of free polyol. In this regard, the free polyol component (e.g., sorbitol, sorbitan and isosorbide) will constitute not more than about 20%, more typically not more than about 15%, still more typically not more than about 10%, by total weight of the sorbitan component.

The sorbitan component of the present compositions will typically comprise not more than about 20%, more typically not more than about 12%, by weight, sorbitol esters.

The sorbitan component of the composition will typically contain not more than about 30% sorbitan diesters. In another aspect, the sorbitan component will contain not more than about 20% sorbitan diesters. In yet another aspect, the sorbitan component will contain not more than about 10% sorbitan diesters. In another aspect, the sorbitan component will contain not more than about 30% sorbitan tri- and tetraesters. In another aspect, the sorbitan component will contain not more than about 20% sorbitan tri- and tetraesters. In yet another aspect, the sorbitan component will comprise not more than about 10% sorbitan tri- and tetraesters.

The nature of the fatty acid moieties esterified to a hydroxyl group of a given sorbitan will depend in part on the end use of the composition. For example, where the sorbitan monoester containing composition will be utilized in making dehydrated ingredients, the sorbitan monoester will typically be esterified with at least about 80%, more typically at least about 90%, and most typically at least about 95%, saturated fatty acids. Further, the sorbitan monoester will typically comprise less than about 20%, more typically less than about 10%, and most typically less than about 5%, by weight, unsaturated cis and trans fatty acids. Preferred fatty acids include C₁₂, C₁₄, C₁₆, C₁₈, C₂₀, and C₂₂ fatty acids. It is preferred that the sorbitan monoesters used herein be esterified with fatty acids chosen from oleic, palmitic and stearic acids; however, fatty acids may range from C₁₂-C₂₂, and may be saturated or unsaturated. In general, in order to avoid any oxidation issues, in certain applications it may be desirable to minimize the level of unsaturated fatty acid esters.

Where the sorbitan monoester containing composition is used in a dough making application, preferred fatty acids include C₁₀, C₁₂, C₁₄, C₁₆, C₁₈, C₂₀, and C₂₂ fatty acids. It is preferred that the sorbitan monoesters used herein be esterified with fatty acids chosen from oleic, palmitic and stearic acids; however, fatty acids may range from C₁₀-C₂₂, and may be saturated or unsaturated.

In general, the following is a non-limiting list of particularly preferred sorbitan monoesters for use in the emulsifier system described herein: sorbitan monopalmitate, sorbitan monostearate, sorbitan monooleate, sorbitan monomyristate, sorbitan monolaurate, and sorbitan monocaprylate.

In another aspect, the present invention is directed to an improved emulsifier system for making various food products including but not limited to dehydrated starch ingredients, wherein the emulsifier system comprises at least about 50%, by weight, of sorbitan monoesters. Other applications include baked goods, confectionaries, sauces, cereals, etc.

While the compositions of the present invention can include sorbitan monoesters as the key emulsifier component, the compositions can include other known, functional emulsifiers. For example, another emulsifier that can be used in the emulsifier system of the present invention, along with the sorbitan monoester component, is diacetyl tartaric acid ester monoglyceride (DATEM). As discussed in the Definitions section, supra, DATEM is a monoglyceride (having an esterified fatty acid ranging from 12 to about 22 carbon atoms) that is esterified with diacetyl tartaric acid.

The compositions can also include polyglycerol esters such as those described in U.S. Ser. No. 09/965,113, filed Sep. 26, 2001; lactic acid esters of mono and diglycerides, (e.g., Grinsted® Lactam, available from Danisco (Kansas City, Kans.)); acetic acid esters of mono and diglycerides (e.g., Grinsted® Lactam, available from Danisco); or ethoxylated esters of mono and diglycerides. Of course, the compositions can comprise mixtures of one or more of these materials together with the sorbitan monoester.

While the emulsifier system of the present invention may include only one or a combination of sorbitan monoesters, it is possible to replace some portion of those emulsifiers with one or more other emulsifiers (including those having relatively lower functionality) and still provide an overall system that exhibits the desired functionality under relevant conditions. This is important because certain emulsifiers are relatively expensive. Accordingly, it may be desirable to have a portion of the emulsifier system comprised of other emulsifiers, so long as the desired functionality of the emulsifier system is maintained.

The ability to use other emulsifiers with the sorbitan monoester(s) and the relative amount of that use will be dictated by several factors, including the functionality of the other emulsifier(s) used. For example, where a ‘highly functional’ sorbitan monoester is used (e.g. a sorbitan monopalmitate), it may be possible to include higher levels of other emulsifiers while maintaining the desired functionality of the entire emulsifier system.

In one such system, the sorbitan monoester(s) can be blended with monoglyceride or mono-diglyceride that is currently used (at relatively high levels) in the dehydration process.

Preferably, the monoglyceride is derived from, for example, hydrogenated or partially hydrogenated soybean oil, rapeseed oil, cottonseed oil, sunflower seed oil, palm oil, palm olein, safflower oil, corn oil, peanut oil, palm stearin, tallow, lard and mixtures thereof. The use of hydrogenated or partially hydrogenated monoglycerides ensures oxidative stability. For these systems, preferred emulsifier systems comprise from about 40% to about 99% sorbitan monoester(s) and from about 60% to about 1% monoglyceride; typically, such a blend will comprise from about 40% to about 60% sorbitan monoester(s) and from about 60% to about 40% monoglyceride.

In another aspect, the sorbitan monoester(s) can be blended with a lecithin to provide an emulsifier system useful herein. In this regard, a preferred emulsifier system comprises not more than about 75%, and most preferably from about 1% to about 25%, of a lecithin, and at least about 25%, most preferably from about 75% to about 99%, of the sorbtian ester component.

In another aspect, the sorbitan monoester(s) can be blended with a polysorbate (polyoxyethylene sorbitan esters) to provide an emulsifier system useful herein. In this regard, a preferred emulsifier system comprises not more than about 75%, and most preferably from about 1% to about 25%, of a polysorbate, and at least about 25%, most preferably from about 75% to about 99%, of the sorbitan component.

In another aspect, the invention relates to an improved emulsifier system useful in making dehydrated starch ingredients, wherein the emulsifier system exists as a stable dispersion at a temperature of at least about 80° C. As discussed, because most processing in the starch dehydration process occurs under high temperature and high moisture conditions, it is believed that emulsifier systems exhibiting the above dispersibility properties are able to function robustly under such typical dehydration conditions. In contrast to emulsifier systems that exist as a stable dispersion at a temperature of at least about 80° C., under the high temperature and high moisture dehydration conditions generally utilized, saturated monoglycerides exist predominantly in the cubic plus water phase, which is a relatively low functional phase. In other words, conventional emulsifier systems do not exist as a stable dispersion at temperatures of about 80° C. or higher.

Applicants have identified emulsifier systems that provide the desired dispersibility under dehydration conditions (i.e., exist as a stable dispersion at a temperature of at least about 80° C.). These emulsifier systems will typically contain at least one emulsifier that itself exists as a stable dispersion. While a given emulsifier system may contain only an emulsifier (or combination of emulsifiers) having those physical properties, it is possible to combine one or more such emulsifiers with other emulsifiers that themselves do not exhibit the desired dispersed phase at a temperature of about 80° C. In general, based on Applicants' discovery and the present disclosure, one can readily select useful emulsifiers based on their ability to form the desired dispersion (as measured according to the Analytical Method section of co-pending U.S. application Ser. No. 09/965,113, filed Sep. 26, 2001 by P. Lin et al.) under the processing conditions indicated herein.

III. Preparation of Sorbitan Component with High Levels of Sorbitan Monoesters

Sorbitan ester (commercial quality) is typically obtained by simultaneous anhydration (also referred to as etherification) and esterification of sorbitol directly with fatty acids. By simultaneously etherifying and esterifying, it is possible to avoid undesirably high concentrations of the 1,4 positional isomer. Such a method of sorbitan ester preparation is described more fully in MacDonald, “Emulsifiers: Processing and Quality Control”, Journal of the American Oil Chemists' Society, Volume 45, October, 1968. As discussed below, to achieve, the high sorbitan monoester content, the commercial sorbitan ester prepared by the above process is molecular distilled to enrich the sorbitan monoester content.

To reduce the level of isosorbide esters, it is preferred that the process of esterification and anhydration be monitored to determine when the sorbitol has been converted to sorbitan such that the reaction can be terminated (neutralization of the catalyst) prior to formation of the bicyclic isosorbide. Additionally, isosorbide ester levels can be further reduced by steam stripping under reduced pressure or molecular distillation

A. Purification/Enrichment

Sorbitan monoesters according to this invention can be prepared using Glycomul®-S, a commercial sorbitan monoester obtained from Lonza Group, Fairlawn, N.J. (this emulsifier comprises 25% sorbitan monoester and less than 15% isosorbide esters; less than 40% 1,4 sorbitan isomers), as a starting material.

In a first step, the predominant portion of the isosorbide esters, along with the free fatty acids, are removed by steam stripping using conventional shortening/oil deodorization equipment.

The following conditions are suitable for sorbitan esters containing palmitic, stearic and oleic fatty acids:

| | |
|---|---|
| Minutes | 100-120 minutes |
| Temperature | 360-400° F. (182-204° C.) |
| Absolute Pressure | 5-10 mm Hg |

At the end of the deodorization step, the level of free fatty acid is typically less than 0.5% and the isosorbide ester content is typically less than 3%.

In the second step, the deodorized sorbitan ester (reduced isosorbide content) can be fractionally distilled, for example using a CMS 15A centrifugal molecular still (CVC Products, Inc., Rochester, N.Y.) using multiple passes. The following conditions are suitable for sorbitan esters containing palmitic, stearic and oleic fatty acids:

| Feed rate | 15 lbs/hr |
|---|---|
| Rotor feed | Gradually increased from 130-190° C. |
| | during the consecutive passes |
| Rotor Residue temperature | 140-220° C. |
| Cooling Water temperature | 30-37° C. |
| Bell Jar pressure | 6-12 micron |
| Distillation cuts for each pass | 10-15% |

The distillate fractions are collected on the surface of the bell jar that is heated to facilitate removal. Distillate and residue are continuously removed by transfer pumps. The fractionation process is monitored by differential scanning calorimetry (DSC), HPLC, and refractive index determinations.

B. Sorbitan Component Synthesis

Alternatively, sorbitan components having high levels of sorbitan monoester can be synthesized from sorbitol and fatty acids using esterification followed by etherification. This synthesis results in low levels of isosorbide and their esters and low levels of 1,4 sorbitan positional isomers.

This process is conducted in a stainless steel reactor equipped with a mechanical agitator, heating and cooling coils, a condenser, and an electric heating jacket. The reactor is charged with sorbitol (e.g., 70%), oleic acid (e.g., Panmolyn 100, Hercules), and NaOH (e.g., 50%) as the esterification catalyst. Mechanical agitation and nitrogen sparging is applied. The temperature is increased to 220° C. The reaction is allowed to proceed for 2-3 hours with the reactor at slightly below atmospheric pressure. Esterification is complete when the free fatty acid is less than 1.5%. The pressure is gradually reduced to 10-15 mm Hg.

The temperature is reduced to 170° C. and phosphoric acid (e.g., 70%) is added to the reactor to initiate the etherification process. A slight amount of water is used to wash all phosphoric acid into the reactor. The temperature is gradually increased to 220° C. for the etherification process. Etherification is conducted until most of the sorbitol esters are converted to sorbitan esters and no significant level of isosorbide esters are formed.

The free fatty acid level in the reaction mixture is determined by titration with base. The etherification endpoint is determined by HPLC according to the Test Methods section below.

After the esterification and etherification processes, the reaction mixture is molecular distilled (according to Section IIIA, above) to produce a sorbitan component with greater than 50% sorbitan monoesters. Because deodorization has already been carried out during synthesis, distillation can be carried out without additional deodorization.

C. Solvent Crystal Fractionation to Enrich Sorbitan Monoester Content

Alternatively or in addition to the procedures described in sections A and B above, sorbitan monoester enrichment may be accomplished using solvent crystal fractionation procedures on crude mixtures. A crude mixture containing sorbitan, sorbitol and isosorbide mixed esters of fatty acids is added to polar solvents, such as methanol or ethanol, at a temperature above the final melting point of the mixture. The mixture is cooled (e.g., to 0-10° C.) and filtered. The filtrate will contain relatively higher concentrations of sorbitan monoester. The crystals or filter cake will contain higher levels of isosorbide esters, sorbitan diesters, and sorbitan triesters. This process can be repeated to further enhance the concentration of sorbitan monoester.

IV. Dehydrated Starch Ingredients and Processing of those Ingredients

As discussed above, Applicants have discovered that sorbitan monoesters are highly functional and therefore compositions containing relatively high levels of these monoesters are useful in emulsifier systems for various purposes. The present invention is directed in one respect to a process for making dehydrated starch ingredients. The process is particularly suitable for making dehydrated potato ingredients. In the context of dehydration processes, saturated monoglycerides are currently used exclusively in the starch dehydration industry. Under the high temperature (typically between 80 and 95° C.) and high moisture (greater than 50% moisture) dehydration conditions generally utilized, saturated monoglycerides exist predominantly in the cubic plus water phase, which is a relatively low functional phase. To compensate for their relatively low functionality under typical dehydration conditions, saturated monoglycerides are typically used at levels of approximately 0.3 to 0.5%, by weight of the resulting dehydrated starch ingredients normalized to 0% moisture content.

Applicants have surprisingly found that compositions containing relatively high levels of the sorbitan monoesters described herein are sufficiently functional in the range of from about 0.005 to about 0.2%, by weight of the resulting dehydrated starch ingredients normalized to 0% moisture content, in the dehydration process. Accordingly, a benefit of utilizing emulsifiers having relatively high levels of sorbitan monoesters is the ability of a formulator of raw materials to reduce the level of the emulsifier needed as a processing aid in the drum drying operation. This reduces the cost of raw materials and also reduces the potential for the formation of off-flavors due to oxidation. By reducing the level of emulsifier in the dehydrated starch ingredients, in fat-free foods such as snacks fried in non-digestible fats like Olean® (sold by the Procter & Gamble Company, Cincinnati, Ohio), the end producer can use other sources of triglycerides while still providing a low-fat food and while meeting the regulatory requirements in many geographies to label the food as “fat free.”

The process of the present invention will be described emphasizing the preparation of dehydrated potato flakes. This is by way of illustration and not limitation. In its broadest aspect, the process of the present invention is generally applicable to the preparation of dehydrated vegetables (e.g., potatoes, sweet potatoes, beets, spinach, onion, carrots, celery, pumpkin, tomatoes, zucchini, broccoli, mushrooms, peas); grains such as corn products (e.g., masa), barley, oats, rye, wheat, rice, amaranth, sago and cassaya; and the like. The present invention is also applicable in producing flakes that can be used in baby foods. The process of the present invention can also be applied for other starch containing materials such as glues and pharmaceutical materials.

Any commercially available potatoes used to prepare conventional potato ingredients such as flakes, flanules or granules can be used to prepare the dehydrated potato ingredients of the present invention. Preferably, the dehydrated ingredients are prepared from potatoes such as, but not limited to, Norchip, Norgold, Russet Burbank, Lady Russeta, Norkota, Sebago, Bentgie, Aurora, Saturna, Kinnebec, Idaho Russet, and Mentor. Any of a variety of potato pieces (as used herein, “potato pieces” includes potato by-products, e.g. slivers, slices nubbins, or slabs) can be used in the practice of the present invention.

In one embodiment the potato pieces are pre-conditioned. As used herein “pre-conditioned” refers to treatments such as blanching and cooling, which causes the potato cells to toughen.

Co-pending U.S. application Ser. No. 09/965,113, filed Sep. 26, 2001 by P. Lin et al., describes the production of dehydrated potato ingredients using polyglycerol esters. The conditions described therein (see in particular page 13, line 5 to page 17, line 8) are also useful in preparing dehydrated potato ingredients in accordance with the present invention. As indicated in the U.S. Ser. No. 09/965,113 application, the emulsifier system of the present invention can be added during or between the cooking, mashing and drying steps, or any combination thereof. To aid in processing, most preferred is where the emulsifier system is combined with the cooked potatoes just prior to or during the mashing step. Additionally, the potato ingredient will exhibit the other properties set forth in U.S. Ser. No. 09/965,113 (see page 17, lines 9-30), other than their possessing sorbitan monoesters as a result of their preparation.

V. Fabricated Farinaceous Products and Baked Goods

Although the disclosure of final products derived from the dehvdiated starch ingredients described above relates primarily to the formation of fabricated chips, it will be readily apparent to one skilled in the art that the dehydrated ingredients can be used in the production of any suitable food product. For instance, the dehydrated potato products can be rehydrated and used to produce food products such as mashed potatoes, potato patties, potato pancakes, potato soup, and other potato snacks such as extruded French fries and potato sticks. For mashed potatoes, potato flakes may be coarsely ground to about 0.1-1 cm². Optionally, seasonings such as salt, pepper, onion powder, garlic powder, MSG, butter flavors, or cheese powder, may be added to the ground flakes before packaging. Additionally, various stabilizers may be added, for example BHT and citric acid. The consumer prepares the mashed potatoes by adding the potato flakes to hot water containing salt, margarine and milk. The product is mixed and is ready for consumption in a few minutes.

Alternatively, dehydrated starch ingredients can be used to produce extruded French fried potato products such as those described in U.S. Pat. No. 3,085,020, issued Apr. 9, 1963 to Backinger et al., and U.S. Pat. No. 3,987,210, issued Oct. 18, 1976 to Cremer. The dehydrated potato products can also be used in breads, gravies, sauces, or any other suitable food product.

As indicated, an especially preferred use of the dehydrated potato ingredients is in the production of fabricated chips made from a dough. Examples of such fabricated chips include those described in U.S. Pat. No. 3,998,975 issued Dec. 21, 1976 to Liepa, U.S. Pat. No. 5,464,642 issued Nov. 7, 1995 to Villagran et al., U.S. Pat. No. 5,464,643 issued Nov. 7, 1995 to Lodge, PCT Application No. PCT/US95/07610 published Jan. 25, 1996 as WO 96/01572 by Dawes et al., and U.S. Pat. No. 5,928,700 issued Jul. 27, 1999 to Zimmerman et al.

U.S. Ser. No. 09/965,113 describes the preparation of farinaceous products from a dough. In particular, the application describes the dough compositions themselves, the preparation of the dough, sheeting of the dough, preparation of dough pieces and frying of the dough pieces to provide the end product. The skilled artisan can refer to the teachings of the '113 application, including relevant materials and ranges of incorporation, in using the dehydrated starch ingredients of the present invention.

VI. Analytical Methods

1. Sorbitan Ester Positional Isomer Determination

This is representative of a method that allows the determination of sorbitan positional isomers from a sorbitan component sample, using a two-step procedure. In the first step, the sorbitan component is converted to sorbitan by saponification. In the second step, the sorbitan is analyzed for its sorbitan isomer distribution using gas chromatography with a flame ionization detector.

1A. Converting Sorbitan Esters to Sorbitan

Equipment

| | |
|---|---|
| Analytical balance | Accurate to 0.1 mg |
| Heating stir plate | CMS #267-914, capable of 160° C., or equivalent |
| Water-jacketed condenser | T/s 24-40 Ground glass joint, CMS #067-470 |
| Magnetic stirring bars | CMS #271-825 |
| Extraction flask | T/s 24-40 Ground glass joint, 250 mL capacity, CMS #095-943 |
| Erlenmeyer flask | Wide mouth, 250 mL, CMS #098-228 |
| Beaker | 150 mL, CMS #029-546 |
| Stirring plate | Unheated, CMS #267-955 |

Reagents

| | |
|---|---|
| Methanol | ACS Reagent Grade |
| Hexane | Bulk |
| Sodium methoxide | Aldrich Catalog # 156256-25 ML (25 wt % methanol) |
| Sodium methoxide solution | Dilute 2 mL sodium methoxide to 100 mL with methanol |
| Exchange resin | Amberlite Monobed, Rohm & Hass, IRN 150 Technical Grade |

1. Place approximately 1 g of sample in a 250 mL extraction flask.

2. Add 100 mL sodium methoxide solution and a stirring bar.

3. Attach the flask to a condenser and place on a heated stir plate, preheated to approximately 160° C.

4. Reflux the sample while stirring rapidly for 30 minutes.

5. Pour 25 mL air-dried exchange resin into a 250 mL wide mouth Erlenmeyer flask.

6. Rinse resin twice with methanol, using approximately 150 mL of solvent for each rinse.

7. Qualitatively transfer the hot methylating solution and stirring bar to the Erlenmeyer containing the resin.

8. Stir the solution and resin on an unheated stir plate for one hour.

9. Filter the solution through two sheets of Whatman #41 filter paper into a 150 mL beaker.

10. Evaporate it to near dryness on a steam bath under a stream of nitrogen.

11. Keep the sample beaker on the steam bath without nitrogen and add about 5-10 mL methanol to dissolve the residue in the beaker.

12. Add about 50 mL hexane to the beaker, swirl the contents and return to heat until most of the methanol layer has boiled away.

13. Decant the hexane layer into a waste solvent container.

14. Repeat Steps 11 through 13 as many times as is necessary to obtain a clear residue. Normally this is three times.

15. Return the residue to the steam bath and evaporate it to dryness under nitrogen.

16. This residue may then be treated as a sorbitan sample and prepared for GC analysis in the same manner.

1B. Sorbitan Positional Isomer Determination by Gas Chromatography

Approximately 3 mg of sorbitan is reacted with 0.5 mL of a suitable agent for silylation of sorbitan hydroxyl groups [typically Tri Sil Z (Pierce), heat for 5-10 min. at about 105° C.]. Sample is injected (1 μL, split injection, 30-35 mL split vent flow, 300° C. injector temperature) onto a 15 M×0.25 mm DB-5 column (J&W) with 0.25 μm film thickness. Helium carrier gas flow rate is about 1 mL/min. The initial column temperature is 100° C. (1 min. hold) and it is programmed at 10° C./min. to 325° C. Detection is by flame ionization detector (FID; temperature=335° C.). Applicants have identified, by gas chromatography/mass spectrometry (GC/MS), 11 peaks with a molecular weight of 452 (chemical ionization m/z 453), that corresponds to the molecular weight of fully silylated sorbitan. The FID areas of these peaks are integrated and the results are normalized to the total area of the 11 peaks. Table 1 below shows retention times and normalized area % for a composition of the present invention. (This sample contains less than 50% 1,4-anhydro-D-glucitol.) NMR data are used along with MS data to identify 1,4-anhydro-D-glucitol, a peak of primary interest. Two other peaks (2,5-anhydro-D-mannitol and 1,5-anhydro-D-glucitol) are confirmed with commercially available standards from the electron ionization (EI) fragmentation patterns and GC retention times. Two other peaks (3,6-anhydro-D-glucitol and 2,5-anhydro-L-iditol) are tentatively identified from their EI mass spectra and from MS/MS spectra of protonated sorbitans. The remaining relevant peaks are not typically identified. (It will be recognized that there will be additional, non-sorbitan peaks in the chromatogram that are not relevant to this analysis.)

TABLE 1

| Retention Time (min.) | Peak Identity | Normalized Area % |
|---|---|---|
| 9.60 | #1 | 0.31 |
| 9.80 | #2 | 2.43 |
| 10.11 | #3 | 27.62 |
| 10.26 | #4 | 10.17 |
| 10.34 | #5 | 16.96 |
| 10.38 | #6 | 5.84 |
| 10.46 | #7 (1,4-anhydro-D-glucitol) | 12.66 |
| 10.49 | #8 | 6.97 |
| 10.54 | #9 | 7.41 |
| 10.78 | #10 | 2.83 |
| 11.30 | #11 | 6.80 |

2. Sorbitan Ester Profiling by Reverse-Phase HPLC

Free polyol and fatty acid esters of sorbitol, sorbitan and isosorbide are separated by gradient elution (water:acetone:methylene chloride) on two Beckman ODS columns. An evaporative light scattering detector is used for eluent detection. Elution order is first by class with unesterified polyols eluting first followed by sorbitol monoesters, sorbitan monoesters and isosorbide monoesters. Analytes with a higher degree of esterification elute after the monoesters and in the same backbone order. Within classes, analytes elute in order of increasing carbon number (acyl chain length).

The detector response for unesterified polyols is lower than the detector response for sorbitan esters. Therefore, to compensate for these differences, percent free polyol per sample is determined using an external sorbitol calibration curve.

Reagents

| | |
|---|---|
| Methylene Chloride | Burdick & Jackson |
| Acetone | Burdick & Jackson |
| HPLC Grade Water | VWR, #JT3140-5 |

Equipment

| | |
|---|---|
| Volumetric Flask | 25 mL |
| LC System | HP-1090L with PV5 pumps, |
| | variable volume injector |
| | equipped with 25 μL syringe and |
| | a temperature controlled |
| | autosampler, or equivalent |
| LC Column | 2 Beckman ODS columns, |
| | 4.6 mm × 25 cm, 5 μm. |
| Laboratory Automation System (LAS) | Hewlett-Packard #3357 |
| Evaporative Light Scattering Detector | Applied Chromatography |
| | Systems #750/14 |
| Autosampler Vials | 2 mL, VWR, #66020963 |
| Autosampler Vial Caps | 11 mm, VWR #66020-963 |
| Disposable Pasteur Pipets | Glass, VWR, #14672-200 |
| Column Inlet Filter | Rheodyne #7335; Alltech Assoc. |
| | #7335RV |
| Replacement Filter Discs | 0.5 μm × 3 mm, Alltech Assoc. |
| | #7335-010 |
| Drierite | Fisher #07-578-4A, |
| | or equivalent |

Sample Preparation

1. Weigh approximately 0.50 g of sample into a 100 mL volumetric flask and add approximately 50 mL of acetone. Warm sample gently to dissolve. Early reaction samples may contain unesterified polyol and appear cloudy in the acetone. As needed, add several drops of water with warming to the sample to clear the solution. Allow solution to cool to room temperature and dilute to volume with acetone.

2. Transfer a portion of each sample to an autosampler vial and cap.

Preparation of Sorbitol Standards for External Calibration Curve

1. Prepare a 1% sorbitol stock solution by first weighing approximately 1 g of sorbitol in a 100 mL volumetric flask.

2. Add 10 mL HPLC grade water and swirl to dissolve the sorbitol completely.

3. Slowly fill volumetric flask to volume with acetone. Solution may become cloudy upon addition. Mix thoroughly.

4. Prepare a 1:50 dilution of sorbitol stock by transferring 1 mL of stock solution into a 50 mL volumetric flask. Fill to volume with acetone.

5. Repeat step 4 to prepare a 3:50, 5:50, 7:50, and 9:50 dilution of sorbitol stock.

6. Transfer a portion of each sample to an autosampler vial and cap.

LC Operation (with Above Specified Equipment)

1. Turn on power for the HP-1090.

2. Filter all solvents with the filtration apparatus.

3. Fill reservoirs with filtered solvent. Reservoir A contains water, reservoir B contains methylene chloride and reservoir C contains acetone.

4. Open helium toggle on back of HP-1090 module and sparge solvent for at least 5-10 minutes. Close helium toggle.

5. Turn on power to the evaporative light scattering detector by depressing the green power button. Allow instrument to warm up for 30 minutes before analysis. Set other detector conditions as follows.

| | | | |
|---|---|---|---|
| Attenuation | 2 | Evaporator Setting | 60 |
| Photomultiplier | 2 | Nitrogen | 15 psi |
| Time Constant | 5 | | |

6. Set up mobile phase program and instrument parameters on the HP-1090 as shown below. Refer to HP-1090 Operators' Handbook for programming directions.

Method 0

| Sorbitan | | |
|---|---|---|
| SDS Config A = 1 B = 1 C = 1 | | |
| Flow = 1 | | |
| % B = 0 % C = 50 | | |
| Max Press = 400 | | |
| Min Press = 0 | | |
| Oven Temp = 40 | | |
| Inj Vol = 20 | | |
| Slowdown = 5 | | |
| Stop Time = 25 | | |
| Post Time = 10 | | |
| Column SW = 1 | | |
| E1 = 1, E2 = 0, E3 = 0, E4 = 0 | | |
| At 0 | % B = 0 | % C = 50 |
| 0 | E4 = 1 | |
| 0.1 | E4 = 0 | |
| 5 | % B = 0 | % C = 80 |
| 10 | % B = 0 | % C = 100 |
| 15 | % B = 0 | % C = 100 |
| 20 | % B = 100 | % C = 0 |
| 22 | % B = 0 | % C = 100 |
| 25 | % B = 0 | % C = 100 |

Calculation of Results

External Sorbitol Calibration Curve: the sorbitol peak is integrated to provide the total sorbitol peak area. Peak areas (dependent variable) are then plotted against the total amounts of sorbitol injected in grams (independent variable) to create the external sorbitol calibration curve.

Percent free polyol: free polyol peaks are integrated and summed to provide the total free polyol peak area. The total free polyol peak area is then used to determine the total amount of free polyol injected based on the external sorbitol calibration curve.

The total amount of sample injected is calculated by multiplying the concentration of the sample solution (in g/100 mL) by the injection volume (in mL).

Percent free polyol (% free polyol) is then determined by dividing the amount of free polyol injected by the total amount of sample injected, and multiplying the quotient by 100.

Percent sorbitan monoesters: all sorbitol ester, sorbitan ester and isosorbide ester component peaks in the resulting LC chromatogram are integrated and summed to provide the total ester component peak area. (Ester component peaks are identified by LC/MS or by LC retention time of standards.) Sorbitan monoester peaks are integrated and summed to provide the total sorbitan monoester peak area. Percent sorbitan monoester (%SME) is determined by dividing the total sorbitan monoester peak area by the total ester component peak area and multiplying by the difference between 100 and the percent free polyol. See equation below:

$$\% SME = \frac{{Area}_{SME}}{\begin{matrix}{Area}_{SME} + {Area}_{SDE} + {Area}_{STE} + \\ {Area}_{STeE} + {Area}_{IME} + {Area}_{IDE} + {Area}_{SE} +\end{matrix}} \times ( \text{100-\% free polyol)}$$

Area_{SME}=total sorbitan monoester peak area, Area_{SDP}=total sorbitan diester peak area, Area_{STE}=total sorbitan triester peak area, Area_{STeE}=total sorbitan tetraester peak area, Area_{IME}=total isosorbide monoester peak area, Area_{IDE}=total isosorbide diester peak area, and Area_{SE}=total sorbitol mono-, di-, tri-, tetra-, penta-, and hexaester peak area.

Percent isosorbide esters: isosorbide ester peaks are integrated and summed to provide the total isosorbide ester peak area. Percent isosorbide esters (%ISE) is determined by dividing the total isosorbide ester peak area by the total ester component peak area and multiplying by the difference between 100 and the Percent free polyol. See equation below.

$$\% ISE = \frac{{Area}_{IME} + {Area}_{IDE}}{\begin{matrix}{Area}_{SME} + {Area}_{SDE} + {Area}_{STE} + \\ {Area}_{STeE} + {Area}_{IME} + {Area}_{IDE} + {Area}_{SE} +\end{matrix}} \times ( \text{100-\%} free polyol )$$

3. Aqueous Dispersion Characterization

Aqueous dispersion characterization is performed in accordance with the method described in Section V-Analytical Methods of co-pending U.S. application Ser. No. 09/965,113, filed Sep. 26, 2001 by P. Lin et al.

### VII. EXAMPLES

The following examples illustrate the improved emulsifier systems, dehydrated ingredients and various food of the present invention. The examples are given solely for the purpose of illustration, and are not to be construed as limitations of the present invention since many variations thereof are possible without departing from its spirit and scope.

A. Composition and Dehydration Examples

### Example 1

An improved emulsifier containing a sorbitan component having a high level of sorbitan monoester (hereafter referred to as “Emulsifier-1”) has the following composition:

Ester Composition

| | |
|---|---|
| 82% | Sorbitan Monoester |
| 2% | Sorbitan diester |
| 14% | Sorbitan |
| 1% | Isosorbide monoester |

Fatty Acid Composition

| | |
|---|---|
| 88% | Palmitic Acid |
| 11% | Stearic Acid |
| 1% | Other fatty acids |

The material is prepared by taking Glycomul®-P and applying the following two enrichment steps. The predominant portion of the isosorbide esters, along with the free fatty acids, are removed by steam stripping using conventional shortening/oil deodorization equipment and the following conditions:

| | |
|---|---|
| Minutes | 110 minutes |
| Temperature | 385° F. (196° C.) |
| Absolute Pressure | 8-10 mm Hg |

At the end of the deodorization step, the level of free fatty acid is less than 0.3% and the isosorbide ester content is less than 1%.

In the second step, the deodorized sorbitan ester is fractionally distilled using a CMS-15A centrifugal molecular still (CVC Products, Inc., Rochester, N.Y.) using 5 passes. The following conditions are used:

| Feed rate | 15 lb/hr, |
|---|---|
| Rotor feed | Gradually increased from 130-190° C. |
| | during the 5 consecutive passes |
| Rotor Residue temperature | 140-220° C. |
| Cooling Water temperature | 30-37° C. |
| Bell Jar pressure | 6-12 micron |
| Distillation cuts for each pass | 10-15% |

The distillate fractions are collected on the surface of the bell jar that is heated to facilitate removal. Distillate and residue are continuously removed by transfer pumps. The fractionation process is monitored by differential scanning calorimetry (DSC), HPLC, and refractive index determinations.

### Example 2

An improved emulsifier containing a sorbitan component having a high level of sorbitan monoester (hereafter referred to as “Emulsifier-2”) has the following composition:

Ester Composition

| | |
|---|---|
| 70% | Sorbitan Monoester |
| 9% | Sorbitan diester |
| 1% | Sorbitan triester |
| 15% | Sorbitan |
| 5% | Isosorbide monoester |

Fatty Acid Composition

| | |
|---|---|
| 86% | Palmitic Acid |
| 13% | Stearic Acid |
| 1% | Other fatty acids |

The material is prepared according to the enrichment procedure described in Example 1.

### Example 3

An improved emulsifier containing a sorbitan component having a high level of sorbitan monoester (hereafter referred to as “Emulsifier-3”) has the following composition:

Ester Composition

Ester Composition

| | |
|---|---|
| 60% | Sorbitan monoester |
| 15% | Sorbitan diester |
| 17% | Free polyol (2% Isosorbide) |

Fatty Acid Composition

| | |
|---|---|
| 90% | Palmitic Acid |
| 8% | Stearic Acid |
| 2% | Other fatty acids |

The material is prepared according to the enrichment procedure described in Example 1.

### Example 4

An improved emulsifier containing a sorbitan component having a high level of sorbitan monoester (hereafter referred to as “Emulsifier-4”) has the following composition:

Ester Composition

Ester Composition

| | |
|---|---|
| 75% | Sorbitan monoester |
| 15% | Sorbitan diester |
| 7% | Free polyol (3% Isosorbide) |

Fatty Acid Composition

| | |
|---|---|
| 15% | Palmitic Acid |
| 5% | Stearic Acid |
| 55% | Oleic Acid |
| 20% | Linoleic Acid |
| 5% | Other fatty acids |

This composition is prepared in a stainless steel reactor equipped with a mechanical agitator, heating and cooling coils, a condenser, and an electric heating jacket. The reactor is charged with 20 kg of sorbitol (70%), 25 kg oleic acid, and 85g NaOH (50%) as esterification catalyst. Mechanical agitation and nitrogen sparging is applied. The temperature is increased to 220° C. The reaction is allowed to proceed for 2-3 hours with the reactor at slightly below atmospheric pressure. Esterification is complete when the free fatty acid is less than 1.5%. The pressure is gradually reduced to 10-15 mm Hg.

The temperature is reduced to 170° C. and 70g of phosphoric acid (70%) is added to the reactor to initiate the etherification process. A slight amount of water is used to wash all phosphoric acid into the reactor. The temperature is gradually increased to 220° C. for the etherification process. Etherification is conducted until most of the sorbitol esters are converted to sorbitan esters and no significant level of isosorbide esters are formed.

The free fatty acid level in the reaction mixture is determined by titration with base. The etherification endpoint is determined by HPLC according to the Test Methods section.

After the esterification and etherification processes, the reaction mixture is molecular distilled (according to Section IIIA) to produce sorbitan component with greater than 50% sorbitan monoesters. Because deodorization has already been carried out during synthesis, distillation can occur without additional deodorization.

### Examples 5-7

A mixture of 66% Russet Burbank and 34% Norkota potatoes having an overall solids level of about 20% and reducing sugars of about 1.6% are washed in room temperature water to remove dirt and any foreign materials. The potatoes are then steam-peeled and cut into 0.625 in. (1.59 cm) thick slices. The slices are then cooked for 30 minutes at a steam pressure of 38-40 psig. The cooked potato slices are then shredded and mashed as they are forced through a die plate. Emulsifier is added to the potato mash in the form of a 5% aqueous dispersion as outlined in the table below. The potato mash is mixed with the dispersion as it is fed through an augur and distributed to two single drum dryers. The potato mash is spread onto the drying drum with four applicator rolls, forming a thin sheet layer of 0.005-0.008 in. (0.013 to 0.020 cm). The drum is rotated at approximately 14-16 s/rev. This results in a dehydrated potato sheet having a moisture content of 7-8%, which is removed from the drum by a doctor knife.

| Properties | Example 5 | Example 6 | Example 7 |
|---|---|---|---|
| Emulsifier added | Emulsifier-1 | Emulsifier-2 | Emulsifier-3 |
| Emulsifier concentration (% | 0.1 | 0.1 | 0.1 |
| in finished dehydrated flakes) | | | |

### Examples 8-14

The following emulsifier systems are used to produce dehydrated potato ingredients in the manner described in Examples 5 through 7:

| | Example No. | | | | | | |
|---|---|---|---|---|---|---|---|
| | 8 | 9 | 10 | 11 | 12 | 13 | 14 |
| Emulsifier-1 | 50% | 0% | 0% | 0% | 0% | 0% | 80% |
| Emulsifier-2 | 0% | 75% | 50% | 90% | 50% | 95% | 0% |
| DATEM | 0% | 0% | 50% | 0% | 0% | 0% | 15% |
| Monoglyceride | 50% | 25% | 0% | 0% | 40% | 0% | 0% |
| Lecithin | 0% | 0% | 0% | 10% | 10% | 5% | 5% |

DATEM: Panodan™ 205, a commercially available DATEM made by Danisco Cultor (New Century, Kans.). It has the following fatty acid composition:

| | |
|---|---|
| 11% | Palmitic acid |
| 87% | Stearic acid |
| 1% | Oleic acid |
| 1% | Other fatty acid |

Monoglyceride: Dimodan® PVP, a commercial distilled monoglyceride available from Danisco Cultor, New Century, Kans.

Lecithin: UltraLec®F is a deoiled, ultrafiltered soybean lecithin available from ADM, Decatur, Ill.

B. Dough and Finished Product Examples

### Example A

A dough composition is prepared that comprises 35% water, 3% dough emulsifier*, and 62% of the following mixture of ingredients:

| Ingredient | Wt. % in mixt. |
|---|---|
| Potato flakes (made according to Example 5) | 60 |
| Potato flanules (XL-Potato Granules from Basic | 13 |
| American Foods, Plover, WI) | |
| Corn Meal (PCPF400 ™ Lauhoff Corn Milling Co., | 12 |
| St. Louis, MO) | |
| Wheat starch (Aytex P ™, ADM, Decatur, IL) | 8 |
| Maltodextrin (DE 18 from Grain Processing, IA) | 7 |

*The dough emulsifier used in the preparation of the dough is Aldo® DO, which is available from Lonza Group, Fairlawn, N.J. Aldo® DO comprises monogiycerides, diglycerides, and triglycerides with the following composition:

| Fatty acid composition | | | Ester composition | |
|---|---|---|---|---|
| | 44% | Oleic acid | 37% | Monoglyceride |
| | 10% | Linoleic acid | 48% | Diglyceride |
| | 39% | Palmitic acid | 12% | Triglyceride |
| | 4% | Stearic acid | 3% | Other species |
| | 3% | Other fatty acid | | |

The potato flakes, potato flanules, corn meal, wheat starch, and maltodextrin are mixed together in a blender. (Alternatively, the maltodextrin may be dissolved in the water before being added to the dough.) The emulsifier is heated to produce a homogeneous liquid. Using a dough mixer the emulsifier is added to the dry mixture followed by water (or water plus maltodextrin) to form a loose, dry dough. The dough is sheeted by continuously feeding it through a pair of sheeting rolls, forming an elastic continuous sheet without pinholes. Sheet thickness is controlled to about 0.02 in. (0.051 cm). The dough sheet is then cut into oval shaped pieces and fried in a constrained frying mold at 375° F. (191° C.) for about 6 seconds to make a finished product. The frying oil is NuSun™ oil. NuSun™ oil is a mid-oleic sunflower oil that is commercially available from ADM (Decatur, Ill.).

### Example B

A dough composition is prepared as in Example A, wherein the dough emulsifier is a di-triglycerol monoester. This dough PGE, referred to as 2,3-1-O, is a developmental sample from Lonza Group (Fairlawn, N.J.). This PGE (2,3-1-O) has the following composition:

| Fatty acid composition | | | Ester Composition | |
|---|---|---|---|---|
| | 90% | Oleic acid | 53% | Diglycerol monoester |
| | 6% | Linoleic acid | 4% | Triglycerol monoester |
| | 3% | Stearic acid | 10% | Diglycerol diesters |
| | 1% | Palmitic acid | 3% | Triglycerol diesters |
| | | | 23% | Unesterified polyglycerol |
| | | | 7% | Other esters |

### Examples C-J

A dough composition is prepared as in Example A, where the flakes and dough emulsifier blend are specified in the following table:

| | Example No. | | | | | | | |
|---|---|---|---|---|---|---|---|---|
| | C | D | E | F | G | H | I | J |
| Potato flakes | Ex. 5 | Ex. 5 | Ex. 6 | Ex. 7 | Ex. 6 | Ex. 6 | Ex. 5 | Ex. 7 |
| Aldo ® DO | 70% | 70% | 50% | 40% | 40% | 50% | 50% | 50% |
| PGE (2, 3-1-O) | 0% | 0% | 50% | 20% | 20% | 0% | 0% | 0% |
| Emulsifier-4 | 0% | 0% | 0% | 0% | 0% | 50% | 30% | 45% |
| NuSun ™ oil | 30% | 25% | 0% | 40% | 35% | 0% | 20% | 0% |
| UltraLec ® F | 0% | 5% | 0% | 0% | 5% | 0% | 0% | 5% |

NuSun™ oil is a mid-oleic sunflower oil that is commercially available from ADM (Decatur, IL). UltraLec® F is a deoiled, ultrafiltered soybean lecithin that is commercially available from ADM (Decatur, Ill.).

### Examples K-R

A dough composition is prepared as in Example A, where the flakes and dough emulsifier blend are specified in the following table:

| | Example No. | | | | | | | |
|---|---|---|---|---|---|---|---|---|
| | K | L | M | N | O | P | Q | R |
| Potato flakes | Ex. 6 | Ex. 5 | Ex. 5 | Ex. 7 | Ex. 5 | Ex. 6 | Ex. 5 | Ex. 5 |
| Aldo ® DO | 0% | 0% | 0% | 0% | 0% | 50% | 50% | 65% |
| PGE (2, 3-1-O) | 0% | 0% | 0% | 0% | 0% | 20% | 20% | 0% |
| Emulsifier-4 | 70% | 70% | 90% | 80% | 40% | 30% | 0% | 0% |
| Span 80 ™ | 0% | 0% | 0% | 0% | 60% | 0% | 30% | 35% |
| Panodan ™ SD | 0% | 0% | 0% | 20% | 0% | 0% | 0% | 0% |
| NuSun ™ oil | 30% | 25% | 0% | 0% | 0% | 0% | 0% | 0% |
| UltraLec ® F | 0% | 5% | 10% | 0% | 0% | 0% | 0% | 0% |

Span 80™ is a commercial sorbitan ester available from Uniqema (Wilmington, Del.). Panodan™ SD is a DATEM available from Danisco Cultor, New Century, Kans. and has the following composition:

Fatty acid composition

| | |
|---|---|
| 64% | linoleic acid |
| 20% | oleic acid |
| 7% | stearic acid |
| 7% | palmitic acid |
| 2% | other fatty acid |

### Examples S-Z

A dough composition is prepared as in Example A, where the flakes and dough emulsifier blend are specified in the following table:

| | Example No. | | | | | | | |
|---|---|---|---|---|---|---|---|---|
| | S | T | U | V | W | X | Y | Z |
| Potato flakes | Ex. 6 | Ex. 7 | Ex. 5 | Ex. 5 | Ex. 6 | Ex. 5 | Ex. 5 | Ex. 7 |
| PGE (2, 3-1-O) | 60% | 70% | 30% | 0% | 0% | 0% | 0% | 60% |
| Emulsifier-4 | 0% | 0% | 50% | 0% | 0% | 0% | 0% | 0% |
| Sorbitan ester* | 0% | 0% | 0% | 75% | 70% | 90% | 80% | 40% |
| Panodan ™ SD | 0% | 0% | 20% | 0% | 0% | 0% | 20% | 0% |
| NuSun ™ oil | 40% | 25% | 0% | 25% | 25% | 0% | 0% | 0% |
| UltraLec ® F | 0% | 5% | 0% | 0% | 5% | 10% | 0% | 0% |

### Examples AA and AB

The following dough emulsifier blends are used to prepare fat-free fabricated chips.

| Ingredient* | Example AA | Example AB |
|---|---|---|
| PGE (2, 3-1, 2-IM) | 17.5% | 35% |
| Lecithin (UltraLec ® P) | 17.5% | 0% |
| Olean ® | 65% | 65% |

*Olean® is available from the Procter and Gamble Company, Cincinnati, Ohio. The lecithin component is a commercial lecithin, UltraLec® P, available from ADM, Decatur, Ill. The PGE, a mixture of di- and triglycerol mono- and diesters of IM fatty acids, is a developmental sample from Lonza Group, Fairlawn, N.J. This PGE has the following composition:

| Fatty acid composition | | Ester Composition |
|---|---|---|
| | 73% oleic acid | 26% diglycerol monoester |
| | 14% palmitic acid | 23% diglycerol diester |
| | 8% stearic acid | 12% triglycerol monoester |
| | 5% linoleic acid | 7% triglycerol diester |
| | | 6% tetraglycerol monoester |
| | | 6% tetraglycerol diester |
| | | 7% unesterified polyglycerols |
| | | 13% other PGEs |

Dough compositions are prepared using the potato flakes prepared in Example 5. Each dough composition comprises 35% water, 3% dough emulsifier, and 62% of the following mixture of ingredients:

| Ingredient | Wt. % in mixture |
|---|---|
| Potato flakes | 74 |
| Potato flanules (XL-granules Basic American Foods, | 10 |
| Plover, WI) | |
| Precooked Waxy Corn Starch (Ultrasperse ®-A) from | 8 |
| National Starch & Chemical Corp., Bridgewater, NJ) | |
| Substituted Waxy Maize (N-Creamer ™ 46 from | 1 |
| National Starch & Chemical Corp.) | |
| Maltodextrin (DE 18 from Grain Processing, IA) | 7 |

The potato flakes, potato flanules, modified starches, and maltodextrin are mixed together in a blender. (Alternatively, the maltodextrin may be dissolved in the water before being added to the dough.) The emulsifier is heated to produce a homogeneous liquid. Using a dough mixer the emulsifier is added to the dry mixture followed by water (or water plus maltodextrin) to form a loose, dry dough. The dough is sheeted by continuously feeding it through a pair of sheeting rolls, forming an elastic continuous sheet without pinholes. Sheet thickness is controlled to about 0.02 in. (0.051 cm). The dough sheet is then cut into oval shaped pieces and fried in a constrained frying mold in Olean® at 375° F. (191° C.) for about 6 seconds to make a finished product.

### Example AC

A dough composition is prepared as in Example A, wherein the dough emulsifier is a 50:50 mixture of triglyceride oil (NuSun™ oil, described above) and 2-1-O, a DGME available from Danisco Cultor (New Century, Kans.) having the following composition:

| Fatty acid composition | | Ester Composition |
|---|---|---|
| | 90% Oleic acid | 79% Diglycerol monoester |
| | 6% Linoleic acid | 2% Triglycerol monoester |
| | 3% Stearic acid | 3% Diglycerol diesters |
| | 1% Palmitic acid | 1% Triglycerol diesters |
| | | 14% Unesterified polyglycerols |
| | | 1% Other esters |

### Example AD

A dough composition is prepared that comprises 35% water, 3% dough emulsifier*, and 62% of the following mixture of ingredients:

| Ingredient | Wt. % in mixt. |
|---|---|
| Potato flakes (Winnemucca Farms, Winnemucca, NV) | 60 |
| Potato flanules (XL-Potato Granules from Basic | 13 |
| American Foods, Plover, WI) | |
| Corn Meal (PCPF400 ™ Lauhoff Corn Milling Co., | 12 |
| St. Louis, MO) | |
| Wheat starch (Aytex P ™, ADM, Decatur, IL) | 8 |
| Maltodextrin (DE 18 from Grain Processing, IA) | 7 |

*The dough emulsifier used in the preparation of the dough comprises Emulsifier 4.

The potato flakes, potato flanules, corn meal, wheat starch, and maltodextrin are mixed together in a blender. (Alternatively, the maltodextrin may be dissolved in the water before being added to the dough.) The emulsifier is heated to produce a homogeneous liquid. Using a dough mixer the emulsifier is added to the dry mixture followed by water (or water plus maltodextrin) to form a loose, dry dough. The dough is sheeted by continuously feeding it through a pair of sheeting rolls, forming an elastic continuous sheet without pinholes. Sheet thickness is controlled to about 0.02 in. (0.051 cm). The dough sheet is then cut into oval shaped pieces and fried in a constrained frying mold at 375° F. (191° C.) for about 6 seconds to make a finished product. The frying oil is NuSun™ oil. NuSun™ oil is a mid-oleic sunflower oil that is commercially available from ADM (Decatur, Ill.).

### Example AE

A mashed potato is made with the following composition:

| | |
|---|---|
| 45 g | Flakes made according to Example 5 |
| 169 g | Water |
| 12 g | Margarine (60% fat) |
| 1 g | Salt |
| 77 g | Milk (Whole) |

Water, margarine & salt are heated to boiling. Milk and flakes are then added and the combination is mixed well. The finished mashed potato is comparable to current commercial mashed potato products.

### Example AF

A decorative frosting for cakes and pastries is made with the following ingredients.

| Ingredient | Wt. % in mixture |
|---|---|
| Sucrose | 14 |
| Corn syrup solids (24 DE) | 2 |
| Salt | 0.1 |
| Sodium carboxymethyl cellulose | 0.1 |
| Sodium citrate | 0.05 |
| Methyl ethyl cellulose (5% solution) | 10-12 |
| Fat | 30 |
| Tween 60 | 0.2 |
| Sorbitan monoester (of Example 1) | 0.4 |
| Water | q.s. to 100% |

To make the frosting, the dry ingredients (sucrose, corn syrup solids, salt, sodium carboxymethyl cellulose, and sodium citrate) are mixed and added to a solution of methyl ethyl cellulose and water. The temperature is raised to 50° C. The fat and the emulsifier system (Tween 60 plus sorbitan monoester) are melted together and the homogeneous mixture is blended with the aqueous mixture with stirring. The final composition is pasteurized, homogenized at a total of 1,500 psi and frozen.

### Example AG

A microwave cake mix is prepared as follows. An emulsifier-shortening blend is prepared by warming soybean oil to a temperature of about 79° C. An emulsifier blend (monoglyceride, propylene glycol monoesters of palm oil, lactic acid esters of monoglyceride and sorbitan ester) is added to the heated oil.

| Ingredient | Percent |
|---|---|
| Monoglyceride (Myverol 1804) | 17 |
| Propylene glycol monoesters of | 18 |
| hydrogentated palm oil | |
| Lactic acid esters of monoglyceride | 5.6 |
| Sorbitan Ester (SME-1) | 4.4 |
| Soybean oil (I-107) | 55 |

A cake mix is prepared by combining the following ingredients.

| Ingredient | Percent |
|---|---|
| Sugar | 41 |
| Flour | 31 |
| Emulsifier-shortening blend | 10.3 |
| Monocalcium phosphate | 0.7 |
| Sodium aluminum phosphate | 0.15 |
| Soda | 1.7 |
| Dicalcium phosphate | 0.3 |
| Guar and Xanthan Gums | 0.2 |
| Salt | 0.6 |
| Starch | 5.2 |
| Cocoa | 8.3 |
| Flavors | Remainder |

The sugar and flour are co-milled as described in U.S. Pat. No. 3,694,230, to Cooke. The co-milled sugar and flour are then added with the shortening and the remaining ingredients in a ribbon blender.

The dry mix (460 g) is then mixed with 144 g eggs, 55 g oil, and 320 g water to make a batter. The mixing time is for 2 minutes at 850 rpm with a portable mixer. The batter has a density of 0.85 g/cc and a viscosity of 5800 cp (at 21° C.). The batter is then baked in a microwave oven (preferably with a carousel) in a Pyrex bowl for 11.5 minutes using 500 watts power.

A cake having a good grain and texture is prepared.

### Example AH

30 g of triglycerol monostearate (Paniplus 504 from the Paniplus Company) and 28 g of sorbitan monoester (SME-1) is melted with 0.87 g of sodium oleate by heating to a temperature of 104° C. This melt is then placed in a stainless steel beaker with 767.4 g of high fructose corn syrup (Isomerose 100 from the Clinton Corn Processing Company) having a temperature of 60° C. and subjected to high shear. The sheared mix is cooled to 32° C. Then 813.8 g of a triglyceride oil (Crisco Oil from the J.M. Smucker Co.) at a temperature of 32° C. is blended into the emulsifier-water dispersion and subjected to additional high shear. The resulting product is a homogeneous emulsion suitable for use, when mixed with additional water or milk, nonfat milk solids and saccharides, to make frozen desserts having good eating quality characteristics, texture, appearance and flavor.

109.4 g of the emulsion is blended in a home mixer running at high speed with 278.7 g of ice water, 93.9 g nonfat milk solids, and 105.0 g of sucrose for about 2 minutes. The resulting aerated mixture has an overrun of about 75%. The aerated mixture is then placed in a freezing compartment at a temperature of about −18° C. for about 5 hours. The resulting product is a frozen dessert that has a density of about 0.62 g/cc and had good texture and appearance.

Example AI

A cake mix is prepared as follows:

| Ingredient | Percent |
|---|---|
| Shortening | 9.14 |
| Sugar | 48.69 |
| Flour | 32.27 |
| Salt | 0.75 |
| Leavening | 1.78 |
| Gums | 0.33 |
| Starches | 2.17 |
| Enrichments, flavors, colors | 4.00 |
| The shortening composition is: | |
| Sorbitan component of Example 1 | 6.9 |
| Propylene glycol monoesters | 18.9 |
| soybean oil (IV-107) | 66.95 |
| soybean oil (IV-8) | 3.35 |

The sugar and flour are co-milled together using the method described in U.S. Pat. No. 3,694,230. The shortening is prepared by mixing the propylene glycol monoester and the sorbitan component at a temperature of about 71° C. This mixture is then added to the remaining ingredients in the shortening. The polyol is allowed to settle out and is separated.

The shortening and co-milled sugar/flour are mixed together. To this mix is then added the remaining ingredients. Cake batters are prepared by using the following formulation:

| | |
|---|---|
| Dry mix | 524 g |
| Egg | 144 g |
| Water | 300 g |
| Oil | 73 g |
| Batter weight per layer | 510 g |

Batters are prepared by mixing the above ingredients for two minutes using a standard home mixer at a medium speed. The batter is weighed into two 20 cm round pans. The layers are baked to doneness; about 37 minutes at 177° C.

A moist, light tasting cake is produced.

### INCORPORATION BY REFERENCE

All of the disclosure of the aforementioned patents, patent applications, publications, and other references are herein incorporated by reference.

1. An emulsifier composition comprising a sorbitan component, wherein the sorbitan component comprises at least about 50%, by weight, sorbitan monoesters and no more than about 10%, by weight, isosorbide esters.

2. The composition of claim 1 wherein the sorbitan component comprises at least about 60%, by weight, sorbitan monoesters.

3. The composition of claim 2 wherein the sorbitan component comprises at least about 70%, by weight, sorbitan monoesters.

4. The composition of claim 2 wherein the sorbitan component comprises from about 60% to about 98%, by weight, sorbitan monoesters.

5. The composition of claim 1 wherein the sorbitan component comprises not more than about 7%, by weight, isosorbide esters.

6. The composition of claim 5 wherein the sorbitan component comprises not more than about 4%, by weight, isosorbide esters.

7. The composition of claim 1 wherein at least about 80%, by weight, of the sorbitan monoesters are esterified with saturated fatty acid groups.

8. The composition of claim 1 wherein the sorbitan monoesters are esterified with fatty acids having from about 12 to about 22 carbon atoms.

9. The composition of claim 1 wherein the sorbitan component comprises not more than about 20%, by weight, total free polyol.

10. The composition of claim 1 wherein the sorbitan component comprises not more than about 50%, by total weight, of a single sorbitan positional isomer.

11. A composition comprising a sorbitan component, wherein the sorbitan component comprises at least about 50%, by weight, sorbitan monoesters and wherein not more than about 50% of the sorbitan positional isomers is the 1,4 positional isomer.

12. An improved emulsifier system for making food or beverage products, the emulsifier system comprising a sorbitan component, wherein the sorbitan component comprises at least about 50%, by weight, of sorbitan monoesters.

13. A process for making dehydrated potato ingredients, the process comprising the steps of:
(a) cooking potato pieces;
(b) forming the cooked potato pieces into a potato mash;
(c) drying the potato mash to provide dehydrated potato ingredients;
(d) optionally comminuting the dehydrated mash; and
(e) adding an emulsifier system anytime prior to formation of the dehydrated potato ingredients in step (c); wherein the emulsifier system comprises a sorbitan monoester or a mixture of sorbitan monoesters.

14. The. process of claim 13 wherein the emulsifier system comprises a soibitan component wherein the sorbitan component comprises at least about 50%, by weight, sorbitan monoesters and no more than about 10%, by weight, isosorbide esters.

15. The process of claim 13 wherein the sorbitan component comprises from about 60% to about 98%, by weight, sorbitan monoesters.

16. A dough composition comprising:
(a) from about 35% to about 85% of a starch-based flour comprising a dehydrated starch ingredient comprising a sorbitan monoester or a mixture of sorbitan monoesters;
(b) from about 15% to about 50% added water; and
(c) optionally a dough emulsifier.

17. A composition comprising an emulsifier system comprising a sorbitan component, wherein the sorbitan component comprises at least about 50%, by weight, sorbitan monoesters and no more than about 10%, by weight, isosorbide esters.

18. The composition of claim 17, wherein said composition is selected from the group consisting of a cosmetic, a hard surface cleaner, a shampoo, a hair conditioner, a personal cleaning product, a lotion, a fabric softener, a pharmaceutical composition, ice cream, whip cream, a whipped topping, a confectionary, a frosting, a bread, a baked good, a sauce, a salad dressing, a snack, and a dehydrated starch ingredient.

19. The composition of claim 17, wherein said composition is selected from ice cream, whip cream, a whipped topping, a confectionary, a frosting, a bread, a baked good, a sauce, a salad dressing, a snack, and a dehydrated starch ingredient.

20. A dehydrated potato ingredient comprising a sorbitan monoester or a mixture of sorbitan monoesters.
